(19) United States
(12) Patent Application Publication
(10) Pub. No.: US 2008/0062155 A1
(43) Pub. Date: Mar. 13, 2008

(54) DISPLAY DEVICE AND METHOD CAPABLE OF ADJUSTING SLEW RATE

(76) Inventors: Chih-Sung Wang, Hsin-Chu (TW); Chih-Hsiang Yang, Hsin-Chu (TW); Pei-Chen Chan, Hsin-Chu (TW); Sheng-Kai Hsu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/681,726

(22) Filed: Mar. 2, 2007

(30) Foreign Application Priority Data
Sep. 7, 2006 (TW) 095133056

(51) Int. Cl. G09G 5/00; G09G 3/36

(52) U.S. Cl. 345/204; 345/87

(57) ABSTRACT

A display device capable of adjusting slew rate includes a display panel, a driving circuit, a storage unit, and a compensating circuit. The display panel includes a plurality of signal lines for signal transmission. The driving circuit is coupled to the display panel for generating driving signals to a signal line of the display panel based on a control signal and a corresponding compensating signal. Data related to each signal line and its corresponding compensating signal is stored in the storage unit. The compensating circuit, coupled to the storage unit and the driving circuit, receives the compensating signal from the storage unit and sends the compensating signal to the driving circuit.

### BACKGROUND OF THE INVENTION

1. Field of the Invention

The present invention relates to a display device and a method capable of adjusting slew rate, and more particularly, to a display device and a method capable of adjusting slew rate based on a built-in lookup table.

2. Description of the Prior Art

Liquid crystal display (LCD) devices are flat panel displays having low radiations, small sizes and low power consumption. Therefore, LCD devices have gradually replaced traditional cathode ray tube (CRT) displays and are widely applied in various products, such as notebook computers, personal digital assistants (PDAs), flat panel televisions or mobile phones.

Reference is made to FIG. 1 for a diagram of a prior art LCD device 1 0. The LCD device 10 includes an LCD panel 12, a source driver 14, a gate driver 16, a plurality of signal lines, and a plurality of connecting lines. The signal lines of the LCD device 10 include a plurality of parallel data lines D₁-D₂ₘ and a plurality of parallel gate lines G₁-G₂ₙ intersecting the data lines D₁-D₂ₘ. The data lines D₁-D₂ₘ respectively transmit signals from the source driver 14 via connecting lines d₁-d₂ₘ, while the gate lines G₁-G₂ₙ respectively transmit signals from the gate driver 16 via connecting lines g₁-g₂ₙ. A plurality of pixel units P are disposed at intersections of the data lines D₁-D₂ₘ and the gate lines G₁-G₂ₙ. Each pixel unit P includes a switch Q, a storage capacitor C_{ST} and a liquid crystal capacitor C_{LC}. When displaying images, the gate driver 16 outputs scan signals to the gate lines G₁-G₂ₙ for turning on the switch Q of a pixel P. Next, the source driver 14 outputs data signals corresponding to display images to the data lines D₁-D₂ₘ so that image data can be written into the storage capacitor C_{ST} and the liquid crystal capacitor C_{LC} of the pixel unit P. Therefore, each pixel unit P can display corresponding images accordingly.

The signal lines of the LCD device 10 can have different resistances due to process variations, and the lengths of the connecting lines d₁-d₂ₘ and g₁-g₂ₙ can vary due to different circuit layouts. Therefore, the signal transmission paths between the source driver 14 and the LCD panel 12 and between the gate driver 16 and the LCD panel 12 can have different resistances. With increasing demands for high-quality and high-resolution applications, the number of the data lines D₁-D₂ₘ and the gate lines G₁-G₂ₙ also increase, and the resistance variations between different signal lines thus become larger. Slew rate, a parameter indicating driving ability, is proportional to the voltage applied to the signal lines and inversely proportional to the resistance of the signal transmission path. If the LCD device 10 adopts a fan-shaped layout, for the data lines disposed in the middle of the LCD device 10 (such as the data line Dₘ) and the data lines disposed at the left and right sides of the LCD device 10 (such as the data line D₁ and the data line D₂ₘ), the connecting line dₘ is shorter than the connecting lines d₁ and d₂ₘ, and the resistance of the connecting line dₘ is thus smaller than that of the connecting lines d₁ and d₂ₘ. Therefore, different data lines transmit data signals having distinct slew rates. Similarly, for the gate lines disposed in the middle of the LCD device 10 (such as the gate line Gₙ) and the gate lines disposed at the upper and lower sides of the LCD device 10 (such as the gate line G₁ and the gate line G₂ₙ), the connecting line gₙ is shorter than the connecting lines g₁ and g₂ₙ, and the resistance of the connecting line gₙ is thus smaller than that of the connecting lines g₁ and g₂ₙ. Therefore, different gate lines transmit scan signals having distinct slew rates.

Reference is made to FIG. 2 for a signal diagram illustrating driving signals transmitted by the data lines and the gate lines of the LCD device 10. In FIG. 2, waveform A (indicated by the bold line) represents the actual driving voltages received by the data lines and the gate lines disposed in the middle of the LCD device 10 (such as the data line Dₘ and the gate line Gₙ), and waveform B (indicated by the dot line) represents the actual driving voltages received by the data lines disposed at the left/right sides of the LCD device 10 (such as the data line D₁ and the data line D₂ₘ) or the gate lines disposed at the upper/lower sides of the LCD device 10 (such as the gate line G₁ and the gate line G₂ₙ). As illustrated in FIG. 2, due to different circuit layouts and/or process variations, the data lines and the gate lines of the prior art LCD device 10 are driven by driving voltages having distinct slew rates. Therefore, the prior art LCD device 10 cannot provide the LCD panel 12 with the same driving ability and the display quality is thus deteriorated.

Reference is made to FIG. 3 for a functional diagram for an LCD device 20 disclosed in U.S. Patent Application Publication No. 20040036670, entitled “CIRCUIT AND METHOD FOR DRIVING A LIQUID CRYSTAL DISPLAY DEVICE USING LOW POWER”. The LCD device 20 includes a display data latch 21, a prior data latch 23, a bias control voltage generator 25, a driver amplifier 27, and a gamma decoder 29. The display data latch 21 receives image data, latches the image data and generates a corresponding k-bit data signal DD based on a control signal S_LATCH, and transmits the data signal DD to the prior data latch 23, the bias control voltage generator 25 and the gamma decoder 29. Based on the data signal DD, the gamma decoder 29 selects one of the 2^{K} reference voltages V_{REF} as an input driving voltage V_{IN} for the driver amplifier 27. The prior data latch 23 latches the k-bit data signal DD based on a control signal BC_CLK and generates a corresponding n-bit prior data PD(n). The signal received by the bias control voltage generator 25 from the display data Latch 21 is represented by an n-bit current data CD(n). The current data CD(n) can include several or all bits of the k-bit data signal DD (n is an integer not larger than k). The bias control voltage generator 25 compares the values of the current data CD(n) and the prior data PD(n), and generates a corresponding m-bit control signal VC(m) based on the difference between the current data CD(n) and the prior data PD(n). Consequently, the driver amplifier 27 can generate an output driving voltage V_{OUT} for an LCD panel based on the control signal VC(m) and the input driving voltage V_{IN}. The prior art LCD device 20 controls driving voltages applied to the LCD panel based on the difference between image data written at a certain point of time and a subsequent point of time.

Reference is made to FIG. 4 for a functional diagram for an LCD device 30 disclosed in U.S. Pat. No. 6,130,541, entitled “ADAPTIVE DRIVER WITH CAPACITIVE LOAD SENSING AND METHOD OF OPERATION”. The LCD device 30 includes a capacitance sensor 32, a driving control circuit 34 and an output driver 36. The capacitance sensor 32 is used for measuring the capacitance of a signal line on the LCD panel (represented by C_{L} in FIG. 4) and for sending the measured capacitance to the driving control circuit 34. The driving control circuit 34 controls the output driver 36 based on the measured capacitance so that the output driver 36 can generate corresponding driving voltage V_{OUT}.

### SUMMARY OF THE INVENTION

One object of the present invention is to provide a display device capable of adjusting slew rate comprising: a display panel including a plurality of signal lines for signal transmission; a driving circuit electrically coupled to the display panel for generating corresponding driving signals to one of the signal line of the display panel based on a control signal and a compensating signal; a storage unit for storing data related to resistances of signal paths between the plurality of signal lines and the driving circuit, and for storing a plurality of corresponding compensating signals; and a compensating circuit electrically coupled to the storage unit and the driving circuit for receiving the compensating signal corresponding to the signal line from the storage unit and for outputting the compensating signal to the driving circuit.

Another object of the present invention is to provide a method for driving a load with signals having identical slew rate comprising: storing a first compensating signal corresponding to a first load in a lookup table; storing a second compensating signal corresponding to a second load in the lookup table; generating a first driving signal for driving the first load based on the control signal and the first compensating signal, wherein the first driving signal has a slew rate when transmitted to the first load; and generating a second driving signal for driving the second load based on the control signal and the second compensating signal, wherein the second driving signal has the slew rate when transmitted to the second load.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art LCD device.

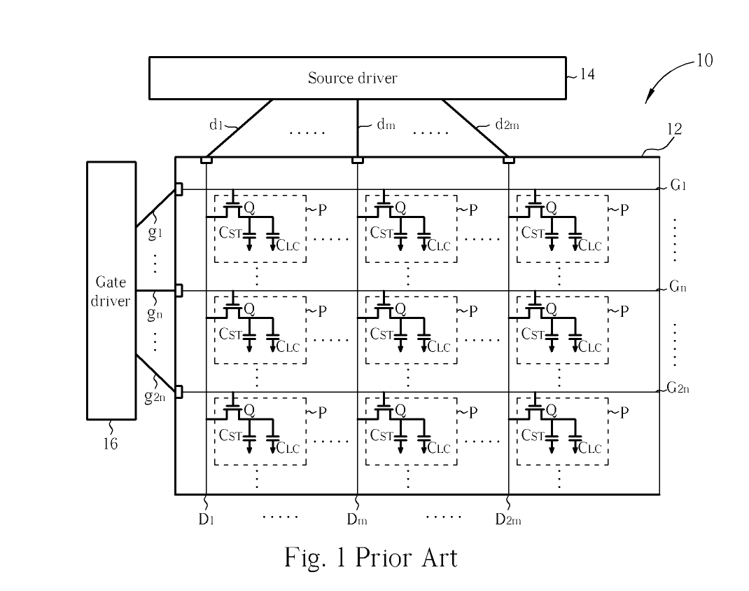

FIG. 2 is a signal diagram illustrating driving signals received by the data lines and the gate lines of the LCD device in FIG. 1.

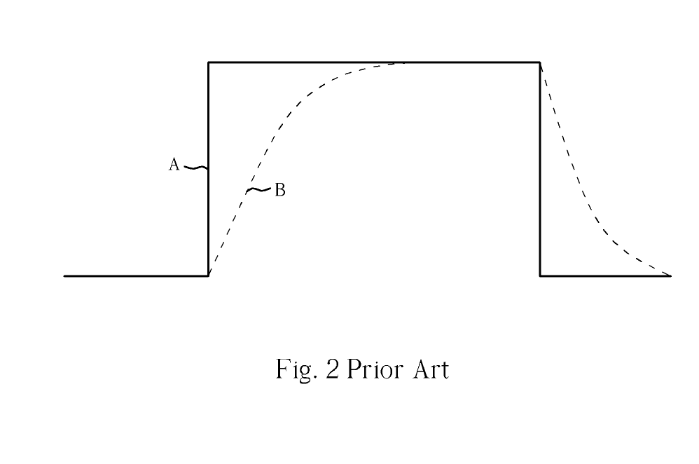

FIG. 3 is a functional diagram of a prior art LCD device.

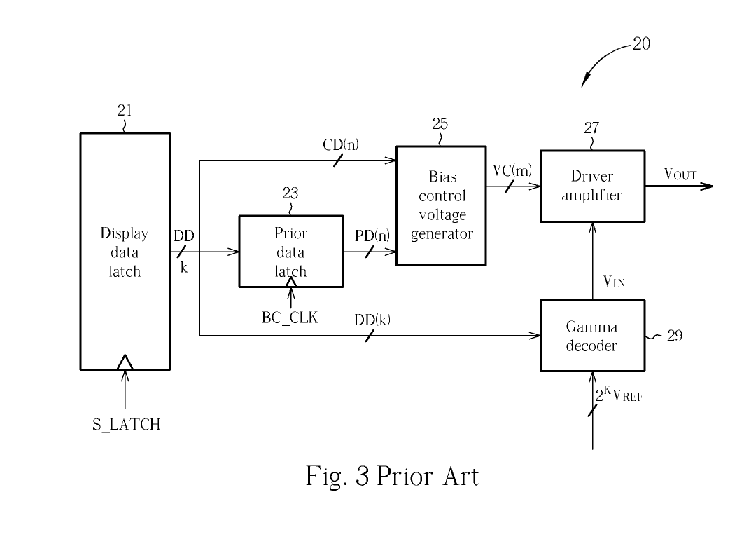

FIG. 4 is a functional diagram of another prior art LCD device.

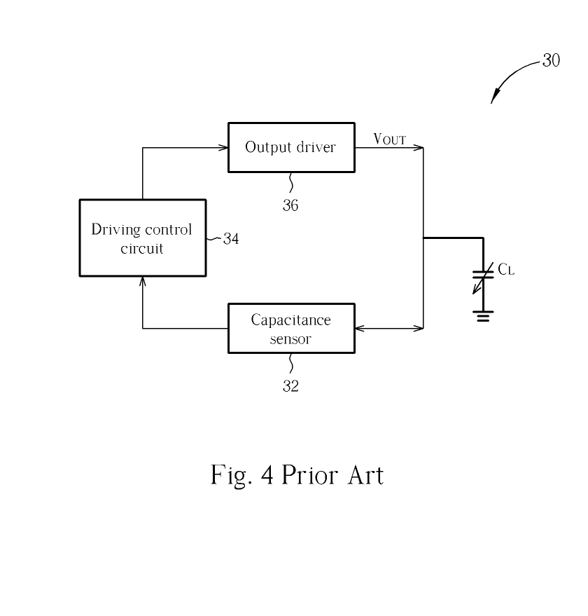

FIG. 5 is a functional diagram of an LCD device according to the present invention.

FIG. 6 is a functional diagram of an LCD device according to the first embodiment of the present invention.

FIG. 7 is a functional diagram of an LCD device according to the second embodiment of the present invention.

FIG. 8 is a signal diagram illustrating driving signals received by the data lines and the gate lines of the LCD device according to the present invention.

### DETAILED DESCRIPTION

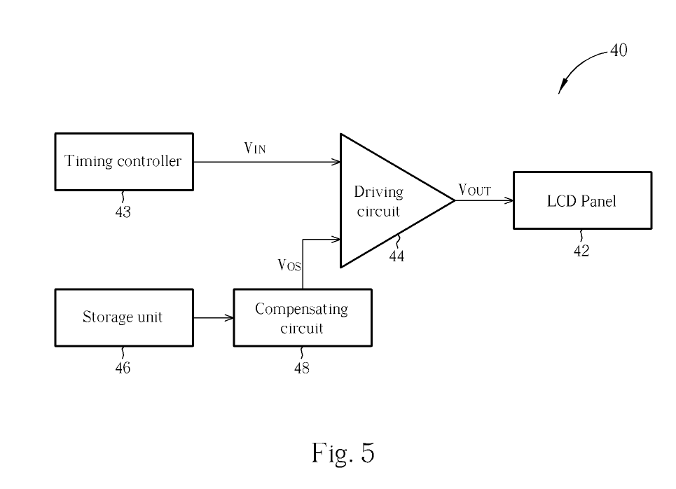

Reference is made to FIG. 5 for a functional diagram of an LCD device 40 according to the present invention. The LCD device 40 includes an LCD panel 42, a timing controller 43, a driving circuit 44, a storage unit 46 and a compensating circuit 48. The timing controller 43 is electrically coupled to the driving circuit 44 and can generate an input driving voltage V_{IN}. The storage unit 46 can store a lookup table (LUT) related to each signal line of the LCD panel 42 and its corresponding compensating signal. The compensating circuit 48 is electrically coupled to the storage unit 46 and the driving circuit 44. When the LCD device 40 drives a signal line of the LCD panel 42, the compensating circuit 48 accesses a compensating signal V_{OS} corresponding to the signal line from the LUT stored in the storage unit 46, and sends the compensating signal V_{OS} to the driving circuit 44. Therefore, the driving circuit 44 can generate a corresponding driving voltage V_{OUT} to be applied to the signal line based on the input driving voltage V_{IN} and the compensating signal V_{OS}.

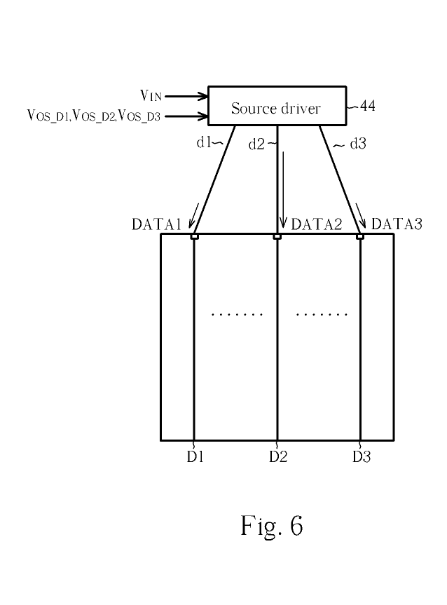

Reference is made to FIG. 6 for a diagram of an LCD device 40 according to the first embodiment of the present invention. As shown, the driving circuit 44 is a source driver of the LCD device 40 and can transmit data signals corresponding to display images to the plurality of data lines of the display panel 42. For ease of explanation, only three data lines D1, D2 and D3 and corresponding connecting lines d1, d2 and d3 are illustrated in FIG. 6. The data lines D1, D2 and D3, respectively representing data lines disposed at the left side, the middle and the right side of the LCD panel 42, receive output driving voltages sent from the source driver 44 via the connecting lines d1, d2 and d3, respectively. The output driving voltages V_{OUT} received by the data lines D1, D2 and D3 are respectively represented by data signals DATA1, DATA2 and DATA3. RD1, RD2 and RD3 respectively represent the resistances of signal transmission paths of the data signals DATA1, DATA2 and DATA3. Since the lengths of the connecting lines d1, d2 and d3 can vary due to different circuit layouts, and the data lines D1, D2 and D3 can have different resistances due to process variations, RD1, RD2 and RD3 can thus have distinct values. According to the preferred embodiment of the present invention, an LUT established based on the connecting line of each data line and its corresponding compensating signal is stored in the storage unit 46. When driving the data lines D1, D2 and D3, the compensating circuit 48 accesses compensating signals V_{OS}_{_{—}}_{D1}, V_{OS}_{_{—}}_{D2} and V_{OS}_{_{—}}_{D3} respectively related to the connecting lines d1, d2, d3 of the data lines D1, D2 and D3. The compensating signals V_{OS}_{_{—}}_{D1}, V_{OS}_{_{—}}_{D2} and V_{OS}_{_{—}}_{D3} are then sent to the driving circuit 44 (i.e., the source driver) for generating corresponding data signals DATA1, DATA2 and DATA3 to the data lines D1, D2 and D3, respectively. In the first embodiment of the present invention, the LCD device 40 adopts a fan-shaped layout in which the connecting line d2 disposed in the middle is the shortest, while the connecting lines disposed at corresponding locations at the left and right sides (such as the connecting line d1 and the connecting line d3) have the same length. Under these circumstances, the resistances of the signal transmission paths have the relationship RD1=RD3>RD2, the compensating signals of the data lines D1, D2 and D3 have the relationship V_{OS}_{_{—}}_{D1}=V_{OS}_{_{—}}_{D3}>V_{OS}_{_{—}}_{D2}, and the data signals received by the data lines D1, D2 and D3 have the relationship DATA1=DATA3>DATA2. Therefore, the resistance variations between different signal paths can be compensated by applying different data signals to the data lines D1, D2 and D3. The data lines can thus be driven with driving signals having identical slew rate, thereby improving the display quality of the LCD device.

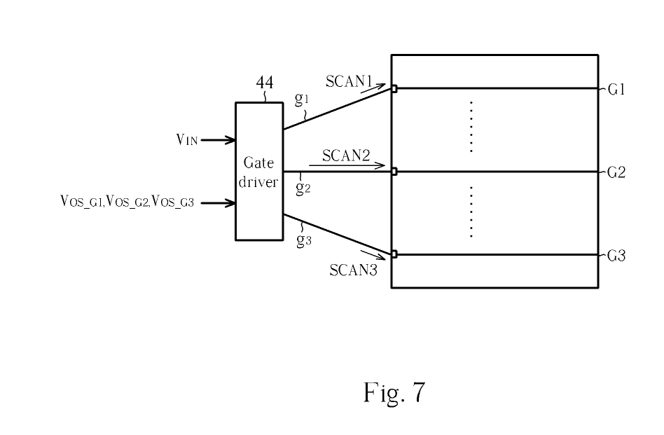

Reference is made to FIG. 7 for a diagram of an LCD device 40 according to the second embodiment of the present invention. As shown, the driving circuit 44 is a gate driver of the LCD device 40 and can output scan signals corresponding to display images to the plurality of gate lines of the display panel 42. For ease of explanation, only three gate lines G1, G2 and G3 and corresponding connecting lines g1, g2 and g3 are illustrated in FIG. 7. The gate lines G1, G2 and G3, respectively representing gate lines disposed at the upper side, the middle and the lower side of the LCD panel 42, receive output driving voltages sent from the gate driver 44 via the connecting lines g1, g2 and g3, respectively. The output driving voltages V_{OUT} received by the gate lines G1, G2 and G3 are respectively represented by scan signals SCAN1, SCAN2 and SCAN3. RG1, RG2 and RG3 respectively represent the resistances of signal transmission paths of the scan signals SCAN1, SCAN2 and SCAN3. Since the lengths of the connecting lines g1, g2 and g3 can vary due to different circuit layouts, and the gate lines G1, G2 and G3 can have different resistances due to process variations, RG1, RG2 and RG3 can thus have distinct values. In the present invention, an LUT established based on the connecting line of each gate line and its corresponding compensating signal is stored in the storage unit 46. When driving the gate lines G1, G2 and G3, the compensating circuit 48 accesses compensating signals V_{OS}_{_{—}}_{G1}, V_{OS}_{_{—}}_{G2} and V_{OS}_{_{—}}_{G3} respectively related to the connecting lines g1, g2, g3 of the gate lines G1, G2 and G3. The compensating signals V_{OS}_{_{—}}_{G1}, V_{OS}_{_{—}}_{G2} and V_{OS}_{_{—}}_{G3} are then sent to the driving circuit 44 (gate driver) for generating corresponding scan signals SCAN1, SCAN2 and SCAN3 to the gate lines G1, G2 and G3, respectively. In the second embodiment of the present invention, the LCD device 40 adopts a fan-shaped layout in which the connecting line g2 disposed in the middle is the shortest, while the connecting lines disposed at corresponding locations at the upper and lower sides (such as the connecting line g1 and the connecting line g3) have substantially the same length. Under these circumstances, the resistances of the signal transmission paths have the relationship RG1=RG3>RG2, the compensating signals of the gate lines G1, G2 and G3 have the relationship V_{OS}_{_{—}}_{G1}=V_{OS}_{_{—}}_{G3}>V_{OS}_{_{—}}_{G2}, and the scan signals received by the gate lines G1, G2 and G3 have the relationship SCAN1=SCAN3>SCAN2. Therefore, the resistance variations between different signal paths can be compensated by applying different scan signals to the gate lines G1, G2 and G3. The gate lines can thus be driven with driving signals having identical slew rate, thereby improving the display quality of the LCD device.

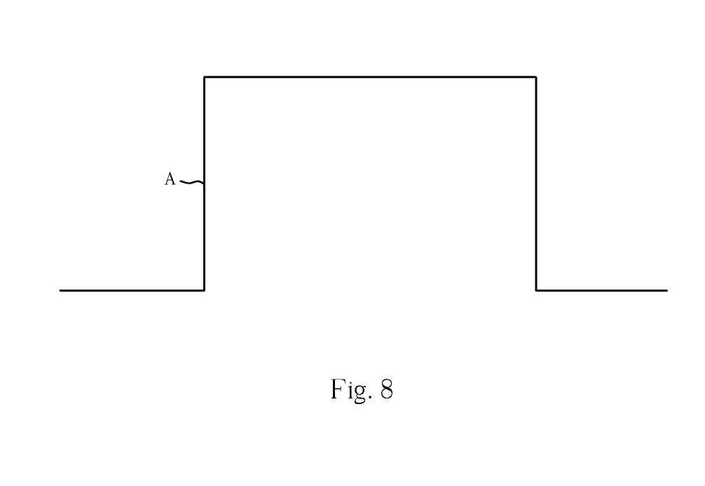

Reference is made to FIG. 8 for a signal diagram illustrating driving signals received at the data lines and the gate lines of the LCD device 40 according to the present invention. In FIG. 8, waveform A represents the actual driving voltages received at each data line and each gate line of the LCD device 40. Since different data signals and scan signals are outputted based on the resistances of each data line and each gate line, each data line and each gate line can thus be driven with driving signals having identical slew rate, thereby improving the display quality of the LCD device.

The compensating circuit 48 can include an application specific integrated circuit (ASIC) or a micro-controller unit (MCU), and the storage unit 46 can include a synchronous dynamic random access memory (SDRAM) or other types of memory. The storage unit 46 can provide compensating signals corresponding to different signal lines by accessing the stored LUT. The driving signals outputted to different signal lines can then be adjusted for compensating the resistance variations between different signal transmission paths. Each signal line can thus be driven with driving signals having identical slew rate, thereby improving the display quality of the LCD device.

In the above-mentioned embodiments, the data lines and the gate lines of an LCD device are used for illustrating the present invention. The outputs of the source driver and the gate driver can be adjusted based on an LUT, so that each data line and each gate line of the LCD device can be driven with driving signals having identical slew rate. However, the present invention is not limited to applications in LCD devices. The present invention can also be applied to display devices and driving methods so as to provide different loads with driving signals having identical slew rate by adjusting the outputs of a driving circuit based on an LUT.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device capable of adjusting slew rate comprising:
a display panel including a plurality of signal lines for signal transmission;
a driving circuit electrically coupled to the display panel, for generating corresponding driving signals to be transmitted to one of the signal lines based on a control signal and a compensating signal;
a storage unit for storing data related to resistances of signal paths between the plurality of signal lines and the driving circuit, and for storing a plurality of corresponding compensating signals;
a compensating circuit electrically coupled to the storage unit and the driving circuit for receiving the compensating signal corresponding to the signal line from the storage unit and for outputting the compensating signal to the driving circuit.

2. The display device of claim 1, further comprising:
a timing controller, electrically coupled to the driving circuit for generating the control signal.

3. The display device of claim 1, wherein the plurality of signal lines are data lines for transmitting driving signals corresponding to display images of the display device, and the driving circuit is a source driver for outputting corresponding driving signals to a data line based on the control signal and the compensating signal.

4. The display device of claim 3, further comprising:
a timing controller, electrically coupled to the driving circuit for generating the control signal corresponding to the display images.

5. The display device of claim 1, wherein the plurality of signal lines are gate lines for transmitting scan signals, and the driving circuit is a gate driver for outputting corresponding driving signals to a gate line based on a control signal and a compensating signal.

6. The display device of claim 5, further comprising:
a timing controller, electrically coupled to the driving circuit, for generating the driving signal corresponding to the scan signal.

7. The display device of claim 1, wherein the compensating circuit comprises an application specific integrated circuit (ASIC).

8. The display device of claim 1, wherein the compensating circuit comprises a micro-controller unit (MCU).

9. The display device of claim 1, wherein the storage unit comprises a synchronous dynamic random access memory (SDRAM).

10. The display device of claim 1, wherein the storage unit stores data related to a resistance of each signal line and the corresponding compensating signal.

11. The display device of claim 1, wherein the storage unit stores a lookup table (LUT) related to each signal line and the corresponding compensating signal.

12. The display device of claim 1, further comprising:
a plurality of connecting lines, electrically coupled to the driving circuit and the plurality of signal lines for transmitting the driving signals.

13. The display device of claim 12, wherein the storage unit stores data related to a resistance of each connecting line and the corresponding compensating signal.

14. The display device of claim 12, wherein the storage unit stores a lookup table related to each connecting line and the corresponding compensating signal.

15. A method for driving a load with signals having substantially identical slew rate comprising:
(a) storing a first compensating signal corresponding to a first load in a lookup table;
(b) storing a second compensating signal corresponding to a second load in the lookup table;
(c) generating a first driving signal for driving the first load based on a control signal and the first compensating signal, wherein the first driving signal has a slew rate when transmitted to the first load; and
(d) generating a second driving signal for driving the second load based on the control signal and the second compensating signal, wherein the second driving signal has the slew rate when transmitted to the second load.

16. The method of claim 15, wherein step (a) comprises storing the first compensating signal corresponding to a resistance of the first load in the lookup table.

17. The method of claim 15, wherein step (b) comprises storing the second compensating signal corresponding to a resistance of the second load in the lookup table.

18. The method of claim 15, wherein step (a) comprises storing the first compensating signal corresponding to a first data line of a liquid crystal display (LCD) device in the lookup table.

19. The method of claim 15, wherein step (b) comprises storing the second compensating signal corresponding to a second data line of the LCD device in the lookup table.

20. The method of claim 15, wherein step (a) comprises storing the first compensating signal corresponding to a first gate line of an LCD device in the lookup table.

21. The method of claim 15, wherein step (b) comprises storing the second compensating signal corresponding to a second gate line of the LCD device in the lookup table.
